(19) United States
(12) Patent Application Publication
(10) Pub. No.: US 2005/0065767 A1
(43) Pub. Date: Mar. 24, 2005

(54) Closed loop integration of digital models of in silico systems and experimental procedures

(75) Inventors: Lawrence F. Arnstein, Seattle, WA (US); Neil A. Fanger, Seattle, WA (US); Michael R. Kellen, Bellevue, WA (US); Zheng Li, Bellevue, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Teranode Corporation, Seattle, WA (US)

(21) Appl. No.: 10/910,958

(22) Filed: Aug. 3, 2004

Related U.S. Application Data
(60) Provisional application No. 60/493,748, filed on Aug. 8, 2003.
(60) Provisional application No. 60/508,109, filed on Oct. 2, 2003.

(51) Int. Cl. G06F 17/50

(52) U.S. Cl. 703/22

(57) ABSTRACT

A method for integrating models of biological systems (i.e., molecules, cells, organs, organisms) that can be simulated with models of laboratory procedures that can be executed, to support close-loop iteration between in silico and physical modeling and experimentation in support of scientific research, discovery, and product development.

### BACKGROUND OF THE INVENTION

1. Field of the Invention

This disclosure generally relates to research, development, and manufacturing, and particularly to tools for automating the performance and documenting of research, development, and manufacturing activities.

2. Description of the Related Art

It is vital for scientists to be able to integrate in silico (computer-generated) predictions with physical experimentation to build more accurate understanding of various systems, for example, biological systems. The lack of formal languages for building system models and for describing experiments makes it difficult, if not impossible, for these processes to be widely distributed or easily automated in a large scale collaborative effort. In addition to lacking formal languages, scientists lack tools that allow them to integrate in silico models of physical systems that encode the scientists predictions with digital experiment protocols and results generated in the physical laboratory.

### BRIEF SUMMARY OF THE INVENTION

It would be desirable to have design and execution software tools based on a visual modeling language that allows scientists to design, annotate, and share information about experimental plans and results as well as model and simulate physical systems, for example, biological systems.

### DEFINITIONS AND BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a functional block diagram of a computing system suitable for embodying at least one embodiment of the invention.

FIG. 2 is a schematic diagram of a closed-loop integration of a software program for design, execution and/or documentation of physical experimental procedures and an in silico software program for design, execution and/or analysis of in silico models of physical systems, according to one illustrated embodiment.

FIG. 3 is a screenshot of a user interface of an adaptive workflow tool according to at least one embodiment, illustrating a graphical view of a digital model of an in silico physical system, such as a biological system.

FIG. 4 is a screenshot of a user interface of an adaptive workflow tool according to at least one embodiment, illustrating a graphical view of a family of in silico physical systems.

FIG. 5 is a screenshot of a user interface of an adaptive workflow tool according to at least one illustrated embodiment, illustrating a graphical view of a physical laboratory procedure.

FIG. 6 is a screenshot of a user interface of an adaptive workflow tool according to at least one illustrated embodiment, illustrating a graphical view of a portion of a physical laboratory procedure including plots illustrating mathematical relationships between parameters in the digital models of the experimental procedure and the in silico physical systems.

FIG. 7 is a screenshot of a user interface of an adaptive workflow tool according to at least one illustrated embodiment, illustrating an exemplary laboratory procedure.

FIG. 8 is a screenshot of a user interface of an adaptive workflow tool according to at least one illustrated embodiment, illustrating a graphical view of digital models of a family of in silico physical systems and an experimental or laboratory procedure in a in a single software environment.

FIG. 9 is a screenshot of a user interface of an adaptive workflow tool according to at least one illustrated embodiment, illustrating a family of in silico physical systems and plots of results for each of the in silico physical systems.

FIG. 10 is a screenshot of a portion of a user interface of an adaptive workflow model in the form of a graphical model or Sample Flow Graph (SFG) illustrating the automatic execution of a simplex algorithm to optimize parameters over four sets of experimental data, according to at least one illustrated embodiment.

FIG. 11 is a screenshot similar to that of FIG. 10, illustrating that the system correctly evaluates the defined expression.

FIG. 12 is a screenshot similar to that of FIG. 11, illustrating that the system preprocesses a parameter or function correctly.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with batch-based procedure design have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present invention. Thus, the appearance of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

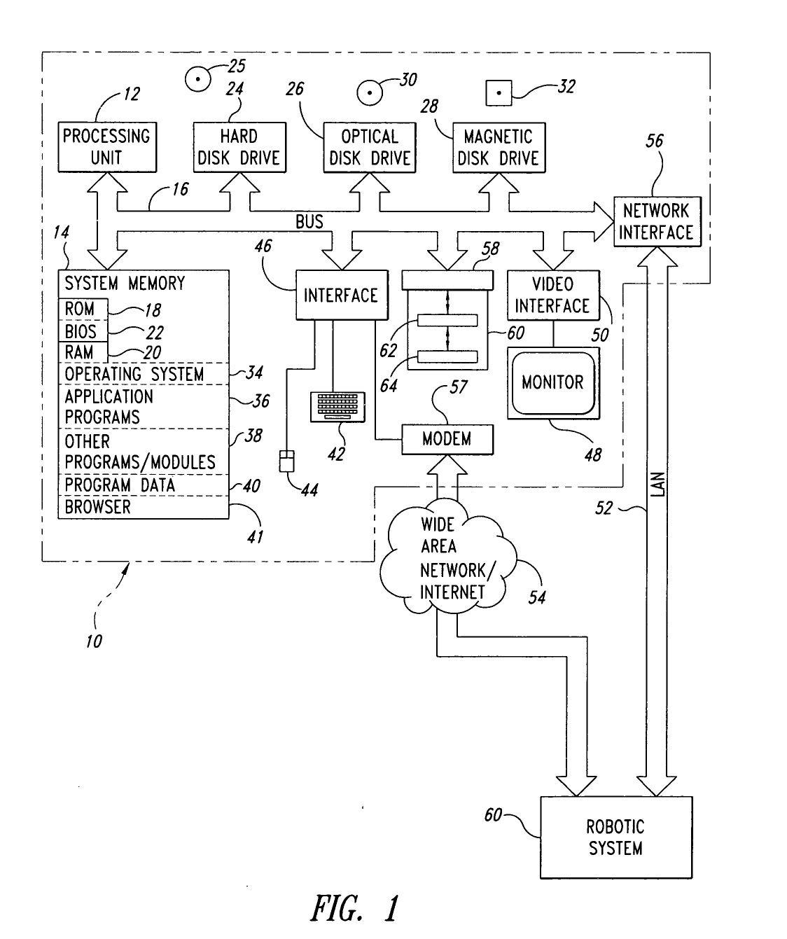

FIG. 1 and the following discussion provide a brief, general description of a suitable computing environment in which embodiments of the invention may be implemented. Although not required, embodiments in the invention will be described in the general context of computer-executable instructions, such as program application modules, objects, or macros being executed by a personal computer. Those skilled in the relevant art will appreciate that the invention can be practiced with other computing system configurations, including handheld devices, multiprocessor systems, microprocessor-based or programmable consumer electronics, network PCs, minicomputers, mainframe computers, and the like. The invention can be practiced in distributed computing environments where tasks or modules are performed by remote processing devices, which are linked through a communications network. In a distributed computing environment, program modules may be located in both local and remote memory storage devices.

Referring to FIG. 1, a conventional personal computer referred to herein as a computing system 10 includes a processor unit 12, a system memory 14 and a system bus 16 that couples various system components including the system memory 14 to the processing unit 12. The processing unit 12 may be any logical processing unit, such as one or more central processing units (CPUs), digital signal processors (DSPs), application-specific integrated circuits (ASIC), etc. Unless described otherwise, the construction and operation of the various blocks shown in FIG. 1 are of conventional design. As a result, such blocks need not be described in further detail herein, as they will be understood by those skilled in the relevant art.

The system bus 16 can employ any known bus structures or architectures, including a memory bus with memory controller, a peripheral bus, and/or a local bus. The system memory 14 includes read-only memory (“ROM”) 18 and random access memory (“RAM”) 20. A basic input/output system (“BIOS”) 22, which can form part of the ROM 18, contains basic routines that help transfer information between elements within the computing system 10, such as during startup.

The computing system 10 also includes one or more spinning media memories such as a hard disk drive 24 for reading from and writing to a hard disk 25, and an optical disk drive 26 and a magnetic disk drive 28 for reading from and writing to removable optical disks 30 and magnetic disks 32, respectively. The optical disk 30 can be a CD-ROM, while the magnetic disk 32 can be a magnetic floppy disk or diskette. The hard disk drive 24, optical disk drive 26 and magnetic disk drive 28 communicate with the processing unit 12 via the bus 16. The hard disk drive 24, optical disk drive 26 and magnetic disk drive 28 may include interfaces or controllers coupled between such drives and the bus 16, as is known by those skilled in the relevant art, for example via an IDE (i.e., Integrated Drive Electronics) interface. The drives 24, 26 and 28, and their associated computer-readable media, provide nonvolatile storage of computer-readable instructions, data structures, program modules and other data for the computing system 10. Although the depicted computing system 10 employs hard disk 25, optical disk 30 and magnetic disk 32, those skilled in the relevant art will appreciate that other types of spinning media memory computer-readable media may be employed, such as, digital video disks (“DVD”), Bernoulli cartridges, etc. Those skilled in the relevant art will also appreciate that other types of computer-readable media that can store data accessible by a computer may be employed, for example, non-spinning media memories such as magnetic cassettes, flash memory cards, RAMs, ROMs, smart cards, etc.

Program modules can be stored in the system memory 14, such as an operating system 34, one or more application programs 36, other programs or modules 38, and program data 40. The system memory 14 also includes a browser 41 for permitting the computing system 10 to access and exchange data with sources such as websites of the Internet, corporate intranets, or other networks, as well as other server applications on server computers. The browser 41 is markup language based, such as hypertext markup language (“HTML”), and operate with markup languages that use syntactically delimited characters added to the data of a document to represent the structure of the document.

While shown in FIG. 1 as being stored in the system memory 14, the operating system 34, application programs 36, other program modules 38, program data 40 and browser 41 can be stored on the hard disk 25 of the hard disk drive 24, the optical disk 30 and the optical disk drive 26 and/or the magnetic disk 32 of the magnetic disk drive 28. A user can enter commands and information to the computing system 10 through input devices such as a keyboard 42 and a pointing device such as a mouse 44. Other input devices can include a microphone, joystick, game pad, scanner, etc. These and other input devices are connected to the processing unit 12 through an interface 46 such as a serial port interface that couples to the bus 16, although other interfaces such as a parallel port, a game port or a universal serial bus (“USB”) can be used. A monitor 48 or other display devices may be coupled to the bus 16 via video interface 50, such as a video adapter. The computing system 10 can include other output devices such as speakers, printers, etc.

The computing system 10 can operate in a networked environment using logical connections to one or more remote computers or robotic system, for example, a microfluidic system 60. The computing system 10 may employ any known means of communications, such as through a local area network (“LAN”) 52 or a wide area network (“WAN”) or the Internet 54. Such networking environments are well known in enterprise-wide computer networks, intranets, and the Internet.

When used in a LAN networking environment, the computing system 10 is connected to the LAN 52 through an adapter or network interface 56 (communicatively linked to the bus 16). When used in a WAN networking environment, the computing system 10 often includes a modem 57 or other device for establishing communications over the WAN/Internet 54. The modem 57 is shown in FIG. 1 as communicatively linked between the interface 46 and the WAN/Internet 54. In a networked environment, program modules, application programs, or data, or portions thereof, can be stored in a server computer (not shown). Those skilled in the relevant art will readily recognize that the network connections shown in FIG. 1 are only some examples of establishing communication links between computers and/or robotic systems 60, and other links may be used, including wireless links.

The computing system 10 may include one or more interfaces such as slot 58 to allow the addition of devices either internally or externally to the computing system 10. For example, suitable interfaces may include ISA (i.e., Industry Standard Architecture), IDE, PCI (i.e., Personal Computer Interface) and/or AGP (i.e., Advance Graphics Processor) slot connectors for option cards, serial and/or parallel ports, USB ports (i.e., Universal Serial Bus), audio input/output (i.e., I/O) and MIDI/joystick connectors, and/or slots for memory.

The term “computer-readable medium” as used herein refers to any medium that participates in providing instructions to processor unit 12 for execution. Such a medium may take many forms, including but not limited to, non-volatile media, volatile media, and transmission media. Non-volatile media includes, for example, hard, optical or magnetic disks 25, 30, 32, respectively. Volatile media includes dynamic memory, such as system memory 14. Transmission media includes coaxial cables, copper wire and fiber optics, including the wires that comprise system bus 16. Transmission media can also take the form of acoustic or light waves, such as those generated during radio wave and infrared data communications.

Common forms of computer-readable media include; for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor unit 12 for execution. For example, the instructions may initially be carried on a magnetic disk of a remote computer. The remote computer can load the instructions into its dynamic memory and send the instructions over a telephone line using a modem. A modem 57 local to computer system 10 can receive the data on the telephone line and use an infrared transmitter to convert the data to an infrared signal. An infrared detector coupled to the system bus 16 can receive the data carried in the infrared signal and place the data on system bus 16. The system bus 16 carries the data to system memory 14, from which processor unit 12 retrieves and executes the instructions. The instructions received by system memory 14 may optionally be stored on storage device either before or after execution by processor unit 12.

One set of software instructions in the form of a routine, program or package (i.e., TeraLab) is used to design, execute, and document experimental procedure for physical experiments, while another set of software instructions in the form of a routine, program or package (i.e., TeraSim) is used to design, execute, analyze and generate predictions in silico using digital models of physical systems, for example, biological systems. Disclosed herein are methods to create a closed-loop integration of executable digital models developed using software such as TeraLab and TeraSim. Closed-loop integration of the physical systems and experimental procedure digital models allows:
(A) parameters and results from physical experiments to alter or optimize, either mathematically and/or visually, models of biological systems; and/or
(B) predictions generated from biological models to directly alter, either mathematically and/or visually, parameters describing physical experiments.

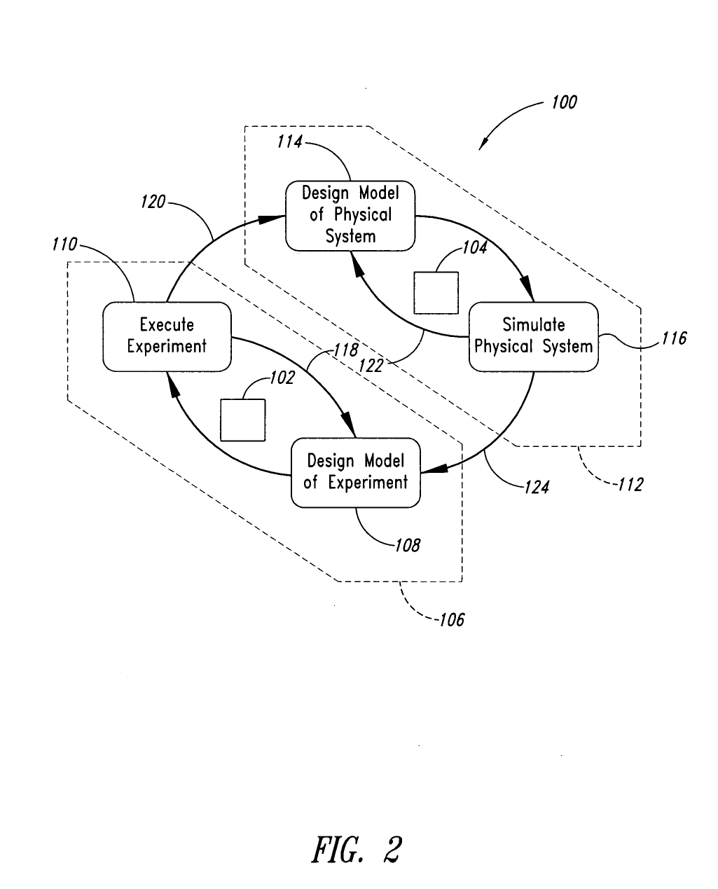

FIG. 2 shows a closed-loop integration 100 of a digital model 102 of an experimental procedure and a digital model 104 of a physical system. A first set of software instructions, designated herein as TeraLab software 106, is used to design 108, execute 110, and document experimental procedure. A second set of software instructions, designated herein as TeraSim software 112, is used to design 114, execute and analyze in silico (i.e., simulate 116) models of physical systems, for example, biological systems. Physical results generated using the TeraLab software 106 and the digital model 102 of the experimental procedure can be used to 1) design further experiments illustrated by arrow 118 and/or 2) validate or optimize model parameters in the digital model 104 of the physical system illustrated by arrow 120. Predictions generated using the TeraSIm software 112 and the digital models 104 of the physical system can be used to 1) update the digital model 104 of the physical system as illustrated by arrow 122 and/or 2) select or optimize parameters of the digital model 102 of the experimental procedure as illustrated by arrow 124.

Integration of executable digital models 102, 104 generated in TeraLab software 106 and TeraSim software 112 results in more rapid iteration of the research cycle and improved communication about systems, for example biological systems, and experiment designs. Some examples of the use of digital models 102, 104 generated via TeraLab software 106 and TeraSim software 112 in an integrated fashion for biological research are described below.

Some of elements useful in supporting closed-loop integration of in silico and physical processes may include:
1. General Data Model. An extensible application independent data model, text representation, and database schema for storing and manipulating hierarchical graph structures (e.g., nodes and edges).
2. Specific Data Models. Data models 102, 104 for representing both systems (e.g., biological systems) and experiment procedures that can be expressed in the general graph structure and database schema described above.
3. Single Graphical Interface. A user interface that allows both model types (i.e., procedural and biological) to be viewed in the same graphical environment, from which integrated spreadsheets and data visualizations can be derived.
4. Parameter Mapping. A mechanism for mapping points in the model's parameter space to, and from, points in the procedure's parameter space within the same modeling environment.
5. Model Management. A mechanism for managing system (e.g., biological) and procedure models, in a distributed system for collaboration, regressing testing and assessment, and automated model validation.
   General Applicability

TeraLab software 106 is a visual-based software tool that is general and flexible enough to design, execute, and document almost any physical or in silico process or procedure in the life and/or physical sciences. The icon set provided by the TeraLab software 106 provides the ability to design biological, biochemical, and chemical experiments and manufacturing processes. Additionally, the same icon set provides the ability to design human clinical trial and patient care protocols. The ability to design these protocols demonstrates the broad applicability of the TeraLab software 16 which can be applied to a broad range of areas when digital models 102 produced using TeraLab software 106 are integrated with digital models 104 produced using TeraSim software 112.

TeraSim software 112 is a visual-based software tool that is flexible enough to model virtually any biological system or process. The TeraSim software 112 is capable of modeling biological and biochemical systems, either non-mathematical or mathematical-based, including signaling pathways, metabolic pathways, electrophysiological systems, cardiac models. The ability to model these biological systems demonstrates the broad applicability of the TeraSim software 112 which can be applied to model virtually any biological, biochemical, or chemical process when digital models 102 produced using TeraSim software 106 are integrated with digital models 104 produced using TeraLab software 112.

### EXAMPLE

While the integration of TeraLab and TeraSim models has applicability to all aspects of physical sciences including life science research, the example presented here focuses on measuring protein-protein binding between the T cell receptor (TCR) and its ligand, the major histocompatibility molecule (MHC), which is a crucial interaction in the mammalian immune system. The following sequence of steps illustrates one embodiment of the closed loop process that is enabled by the methods and/or mechanisms presented in this disclosure. The steps correspond to:
1. Model design
2. Model-driven procedure design and refinement 124
3. Procedure execution and data capture
4. Data-driven model validation, optimization, and refinement 120
   Model Design

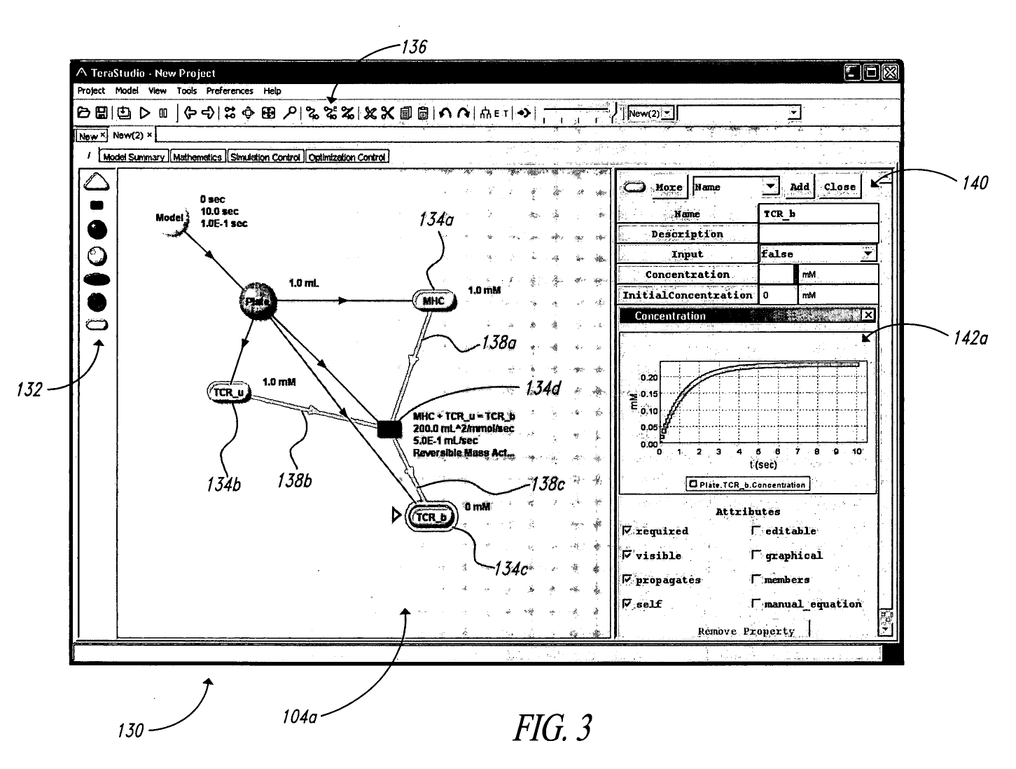

FIG. 3 shows a user interface 130 including a visual representation of a digital model 104a of an in silico physical system. A user can define the digital model 104a by selecting appropriate icons from a variety of menus. For example, selection of an icon from a first set of icons 132, creates a hierarchical node in the digital model 104a. A node icon graphically represents the hierarchical node in a graph structure or flow graph, and a data structure represents the hierarchical node in the schema of the digital model 104a. For example, some of the objects in the digital model 104a of the physical system corresponding to the three chemical species and to the reaction between them may be graphically represented by node icons 134a-134d. Selection of an icon from a second set of icons 136 creates an hierarchical edge in the digital model 104a. A hierarchical edge icon graphically represents the hierarchical edge in a flow graph, and a data structure represents the hierarchical edge in the schema of the digital model 104a. For example, hierarchical edge icons 138a-138c represent relationships between the hierarchical nodes represented by hierarchical node icons 134a-134d.

In particular, FIG. 3 shows a simple digital model 104a of the physical interaction between isolated MCH and TCR. The digital model 104a contains three chemical species: the MHC molecules, the unbound TCR (TCR_u) molecules, and the TCR-MHC compound (TCR_b), graphically represented by hierarchical node icons 134a, 134b, 134c, respectively. These three species are related by a single chemical reaction represented by the dark gray node icon 134d (i.e., a reaction node) in the flow graph. This reaction node specifies that the forward and reverse reactions rates are a function of the species concentrations, and of two rate constant parameters in the model: Kf and Kr.

A property panel 140a shows the mathematical description of the reaction, and the rate constants, Kf and Kr as well as a plot 142a of an independent variable (e.g., exposure time) versus a dependant variable (e.g., concentration of bound TCR). The digital model 104a can be changed in a qualitative way by changing the structure of the digital model 104a and the mathematical relationships, or it can be changed in a quantitative way by altering parameters such as Kf and Kr.

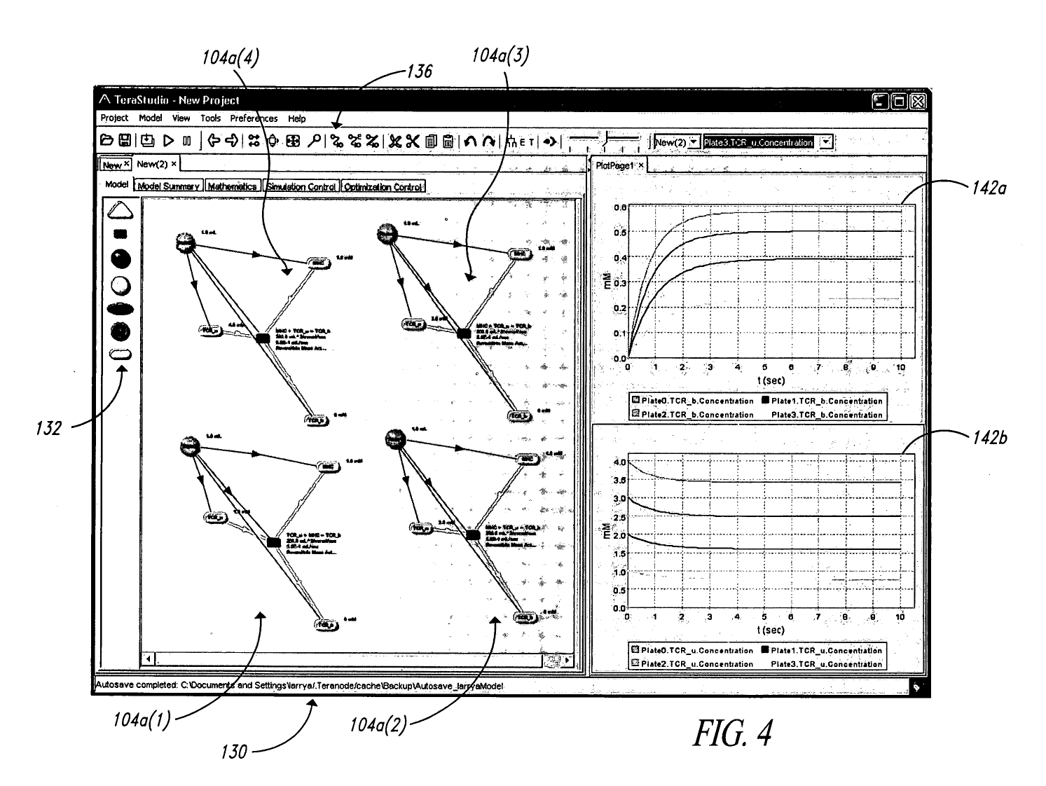

FIG. 4 shows a family of in silico models 104a(1)-104a(4) of physical systems with different values of the independent variable and predicted results. Because of the speed and low cost of the simulation environment, it is possible to try many variations than can be physically performed. In the digital models 104a(1)-104a(4) shown in FIG. 4, the independent variable is the duration of time that the MHC is exposed to unbound TCR. In simulation and analysis environment, the independent variable (exposure time) can be plotted along with the concentration of bound TCR that is predicted by the models 104a(1)-104a(4). For example, the upper plot 142a shows the TCR_b concentration over time for each of the four in silico digital models 104a(1)-104a(4). The lower plot 142b shows that each digital model 104a(1)-104a(4) has a different intiial concentration of the TCR_u reagent, resulting in a different response.

Data-Driven Procedure Design and Refinement

To validate the digital model 104a of the physical system, a few of these in silico representations 104a(1)-104a(4) could be selected for laboratory implementation. Because of the common underlying general graph representation in the executable code, database schema, and file format, digital models 102 of the experimental procedure can be managed and manipulated in the same software environment as digital models 104 of the physical systems.

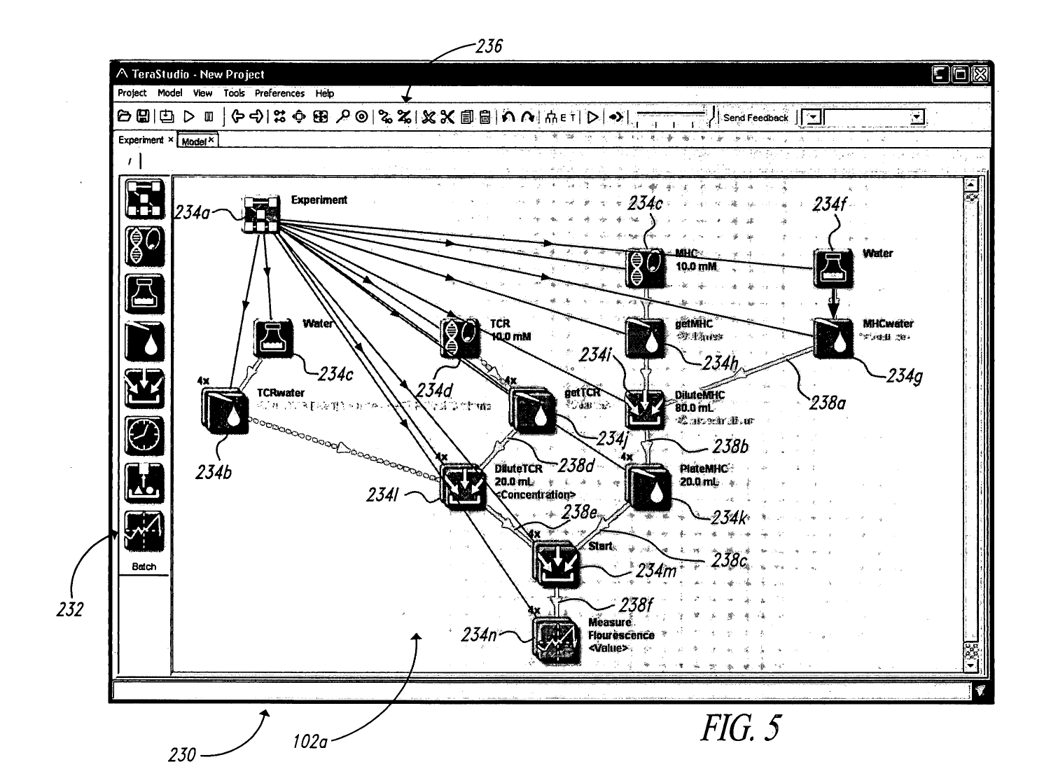

FIG. 5 shows a user interface 230 including a visual representation of a digital model 102a of physical laboratory procedure for a TCR-MCH binding assay. A user can define the digital model 102a by selecting appropriate icons from a variety of menus. For example, selection of an icon from a first set of icons 232, creates a hierarchical node in the digital model 102a. A node icon graphically represents the hierarchical node in a graph structure or flow graph, and a data structure represents the hierarchical node in the schema of the digital model 102a. For example, some of the objects or operations in the digital model 102a of the experimental procedure may be graphically represented by node icons 234a-234n, collectively 234. Selection of an icon from a second set of icons 236 creates an hierarchical edge in the digital model 104a. A hierarchical edge icon graphically represents the hierarchical edge in a flow graph, and a data structure represents the hierarchical edge in the schema of the digital-model 104a. For example, hierarchical edge icons 238a-238f (only some of which are called out in the Figures for sake of clarity), collectively 238 represent relationships between the hierarchical nodes represented by hierarchical node icons 234a-234n.

In particular, FIG. 5 shows a general physical experimental procedure for measuring TCR-MHC binding (i.e., TCR-MCH binding assay). As illustrated and discussed below, the graphical view of the digital model 102a of the experimental procedure may be shown in the same graphical view as the graphical view of the digital model 104a of the in silico physical system. The procedure model 102a indicates that the experiment can be performed on a batch of samples of any size. Exposure time is the independent variable. Each sample of MHC will be prepared in some way and then exposed to TCR for a period of time. Concentrations of MCH and TCR are independent variables, which are specified in the Dilute MCH and Dilute TCR steps, respectively. Once these variables are determined, all of the other unspecified values are accepted by the system using formulas embedded in the flow graph. One such formula for computing the amount of water needed to dilute TCR is shown above. The dependent variable is the fluorescence readout in the measurement operation.

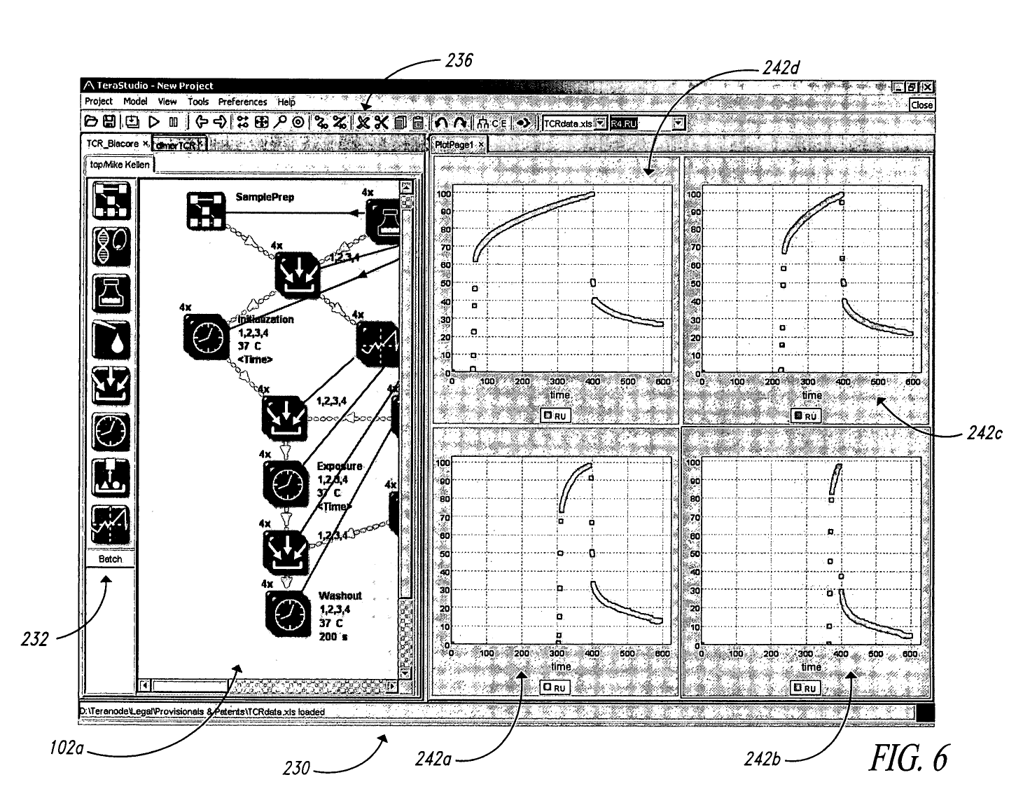

FIG. 6 shows the user interface 230 showing a portion of the graphical representation of the experimental procedure, along with plots 242a-242d illustrating the mathematical relationships between parameters in the digital models 104a, 102a of the in silico physical system and experimental procedure, respectively.

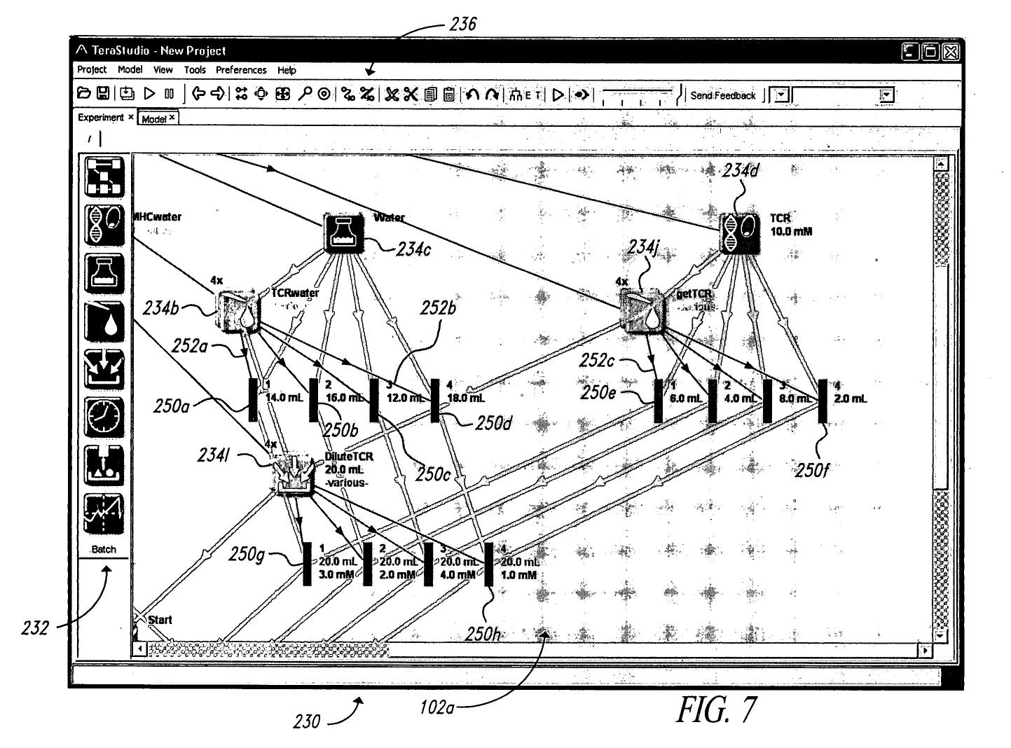

FIG. 7 shows user interface 230 showing a portion of the graphical representation of the digital model 102a of the experimental procedure after manual entry of four values for DiluteTCR.Concentration, all other values in the digital model 102a of the experimental procedure being automatically computed.

Of particular note, FIG. 7 illustrates primitive nodes and primitive edges Which are defined in the digital models 102, 104 by the hierarchical nodes and edges. In particular, a number of primitive nodes and primitive edges are associated with the hierarchical nodes and hierarchical edges by the dimensionality thereof. The primitive nodes may be represented graphically by primitive node icons 250a-250h (only some called out in the Figures for sake of clarity), collectively referenced as 250, and primitive edge icons 252a-252c (only some called out in the Figures for sake of clarity), collectively referenced as 252. The digital model 104 of physical system may have similar primitive nodes and edges associated with the hierarchical nodes and edges.

The common execution environment enables parameters in the two digital models 102, 104 to be mathematically related either directly or otherwise so that these values do not have to be manually entered. Rather, the values can be determined from in silico physical experimental models selected by the user. For example, the four concentrations of TCR and one of MHC can be expressed in terms of model parameters for each of the digital models 104a(1)-104a(4) of the four in silico system physical models of FIG. 4. In this case, the Procedure.Exposure.Time parameter of the digital model 102a of the experimental procedure is computed from the InSilico.ExposureTime parameter in the digital model 104a of the in silico physical system. The number samples in the digital model 102a, which is determined by the Procedure.Samples.Columns parameter is computed from the number of digital models 104a of in silico physical systems selected by the user. Also for example, the amount of TCR that is bound to the plate during each incubation phase is measured by recording the intensity of fluorescence given off by each sample in the concurrent “Measure” operation. The measure operation may be visually distinguished, for example being displayed as red to indicate that the data has not yet been captured. Once acquired, this data can be statistically or visually compared directly to model predictions.

For example, the user may select three of the four digital models 104a(1)-104a(4) of in silico physical systems to map onto the digital model 102a of the experimental procedure model. The digital model 102a of the experimental procedure is automatically configured for a batch of three samples, and the Procedure.Exposure.Time parameters for each sample is automatically computed from the three selected digital models of the in silico physical system.

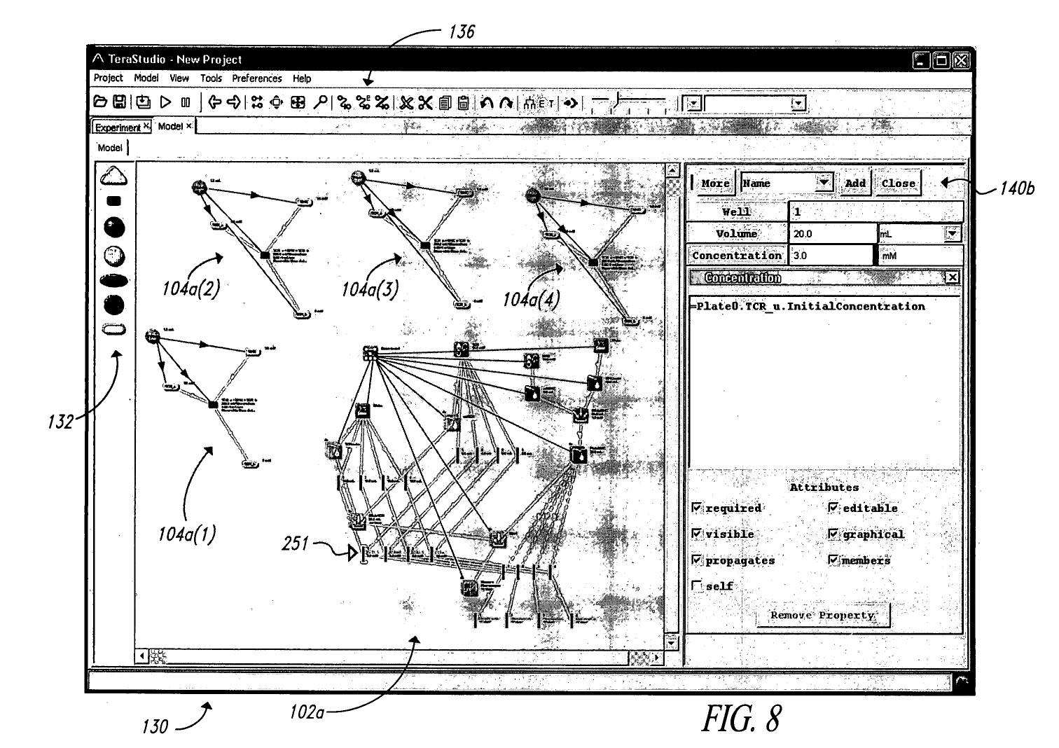

FIG. 8 shows the how the theoretical (i.e., simulated) and empirical (i.e. measured) outputs of the digital models 104a(1)-104a(4), 102a, respectively, can be directly compared graphically and computationally in the same software environment within the same computational framework. The different graphical representations of the different digital models 104a(1)-104a(4), 102a displayed in a single view of a common user interface 130. The properties of the combine hierarchical node represented by combine node icon pointed to by the cursor 251 is displayed in the properties panel 140b, showing the values of the volume and concentration of unbound TCR. The concentration is specified as a function of the TCR_u concentration in one of the digital models of the in silico physical systems (i.e., Plate 0). This evaluates to 3 mM, allowing all of the other experimental parameters to be computed as in the previous Figure.

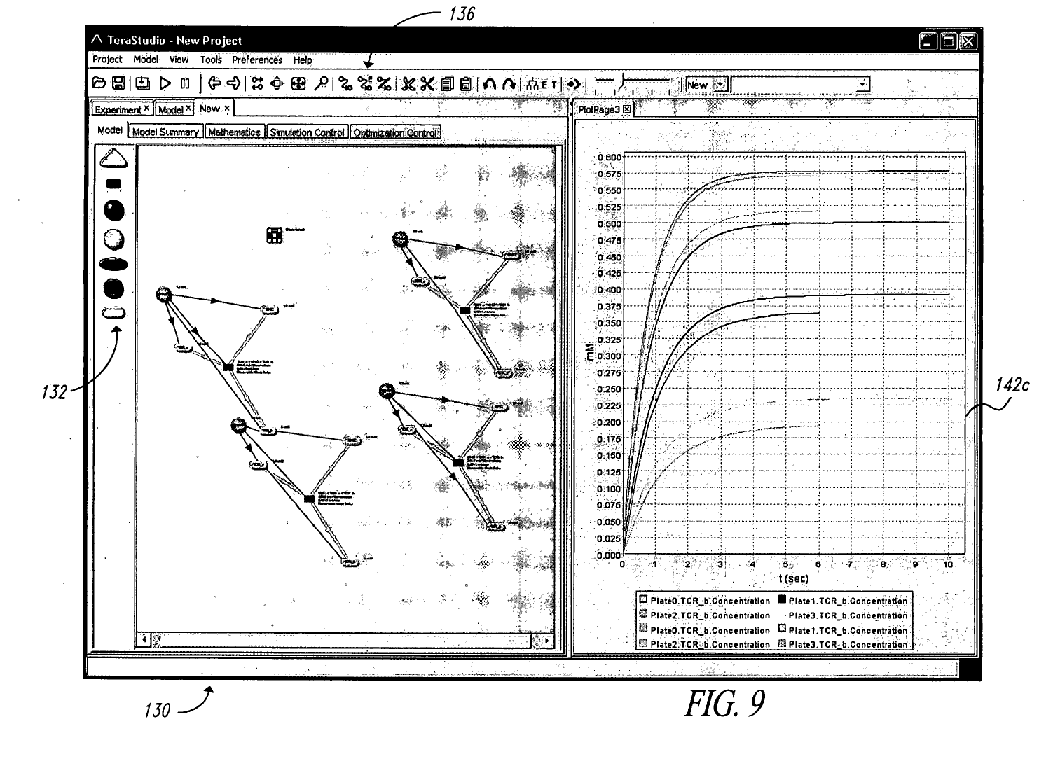

After completing the physical experiments, the entire procedure is highlighted, for example in blue, and the data for each of the four results are available and plotted 142c as illustrated in FIG. 9. By juxtaposing the input stimulus with simulated and measured responses or outcomes, the scientist can better understand how well their model matches observations. Validation of the model can include statistical metrics of how well the predicted and actual data match or could be based on qualitative assessment. The next step in the process is to attempt to find values of model parameters that minimize the error (e.g., least-squared error) between the predicted and actual curves for all four experiments. This is termed model optimization.

In particular, FIG. 9 shows a plot 142c for each of four experimental procedures superimposed with predictions from each of the digital models of the four in silico physical systems. The common execution environment allows data captured in the laboratory to be directly compared to predictions. Subsequent model changes can then be tested in the laboratory by automatically configuring experimental models in a closed loop process. Thus, FIG. 9 shows a comparison of predictions from the optimized model with the original measured data. The common environment allows model and physical data to be juxtaposed.

Data-Driven Model Validation, Optimization, and Refinement

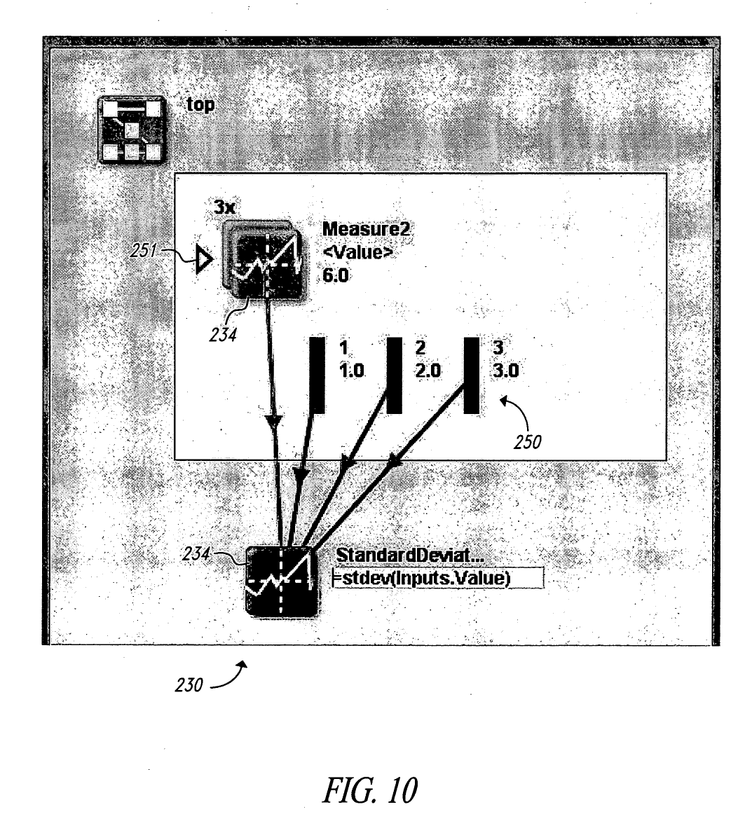

FIG. 10 shows the results of the system 10 (FIG. 1) automatically running a simplex algorithm to optimize the two rate constant parameters, Kf and Kr over the four sets of experimental data. The experimenter is now free to continue the process of model refinement and experiment design. In this case, a qualitative difference between the model and the data still persists. If this difference is considered important, new models structures or mathematical relationships can be rapidly compared to all existing experimental data. The integrated modeling environment allows such comparisons to take place automatically for a large data and model library. This regression testing capability allows many people to collaborate on model development and experimentation.

The following provides more details on one implementation of the capabilities described above, specifically relating to: the general graph and math data model and to keyword replacement techniques
1. A universal graph-and-math object model and storage schema that allows simulation models and procedure models to coexist in the same file, database, and internal data structures.
2. A set of key words that can be used in math expressions which refer to the object's context in the graph structure. This greatly simplifies development and maintenance of the mathematical relationships within and between models.
   The Data Model

Both procedure and biological system models can be represented in a single relational database schema defined as follows. The two types of model can coexist in the same database instance and in the same in-memory object model.

Object 1: Nodes

SQL: CREATE TABLE TERAGRAPH.NODE (GUID VARCHAR (50) NOT NULL, TYPE VARCHAR (50) NOT NULL, FULLPATH VARCHAR (50) NOT NULL, DELETED CHARACTER (5), PRIMARY KEY (GUID))

Field Explanations
GUID=Globally Unique ID for the Node (primary key)
TYPE=String defining the node type. Type is application specific and not constrained by the schema. All nodes types can be stored in the same schema.
FULLPATH=Sequence of GUID for nodes that contain this node. A node can only be found on one hierarchical path.
DELETED=A flag to indicate when the node has been deleted
   Object 2: Edges
   SQL: CREATE TABLE TERAGRAPH.EDGE (GUID VARCHAR (50) NOT NULL, “FROM” VARCHAR (50) NOT NULL, “TO” VARCHAR (50) NOT NULL, TYPE VARCHAR (50) NOT NULL, PRIMARY KEY (GUID))

Field Explanations
GUID=globally unique ID for this edge (primary key)
TYPE=String defining the node type. Type is application specific and not constrained by the schema. All nodes types can be stored in the same schema.
FROM and TO=GUIDs of nodes that represent the source and sink for this edge. These are quoted to overcome a keyword compatibility issue with Oracle's DB system.
   Object 3: Node Properties
   SQL: CREATE TABLE TERAGRAPH.NPROP (GUID VARCHAR (50) NOT NULL, NAME VARCHAR (50) NOT NULL, TYPE VARCHAR (50) NOT NULL, SETON VARCHAR (50) NOT NULL, SETBY VARCHAR (50) NOT NULL, ATTRIBUTES VARCHAR (200) NOT NULL, EXPR VARCHAR (3000) NOT NULL, UNIT VARCHAR (50), DOMAIN VARCHAR (100), VALUELOB BLOB (100 M) NOT LOGGED COMPACT, PRIMARY KEY (GUID, NAME))

Field Explanations
GUID=Guid of the Node that this property belongs to.
NAME=Key for this property. E.g. Volume, Concentration. Must be unique with respect to the node to which this property belongs. GUID+NAME is the primary key for this table.
TYPE=String representing the data type for this property. Any data type can be stored in this schema as long as it has a string or mathematical representation.
SETBY=User ID for last time this property value changed
SETON=When this property value was last changed
ATTRIBUTES=set of true/false values associated with this Node. Attributes are application dependent.
EXPR=The value of the property. Can be a constant value (“2”) or (“Dog”). Or, it can be an mathematical expression referring to other property values. As in “Model1.Species1.Concentration” which refers to the Concentration of Species 1 in Model1. In terms of the data model: “Concentration” is the Name field of a property whose GUID field refers to a node that has a Name property with the value “Species”. And Model1 is the value of a Name property for a node whose GUID appears in the FULLPATH field of the Species node!
   Object 4: The Edge Property Table

This is the same as the node property table except that the GUID field refers to Edge table rather than the Node table.

SQL: CREATE TABLE TERAGRAPH.EPROP (GUID VARCHAR (50) NOT NULL, NAME VARCHAR (50) NOT NULL, TYPE VARCHAR (50) NOT NULL, SETON VARCHAR (50) NOT NULL, SETBY VARCHAR (50) NOT NULL, ATTRIBUTES VARCHAR (200) NOT NULL, EXPR VARCHAR (100) NOT NULL, UNIT VARCHAR (50), DOMAIN VARCHAR (100), VALUELOB BLOB (100 M) NOT LOGGED COMPACT, PRIMARY KEY (GUID, NAME))

Note: The SQL definitions of the database schema are for IBM DB2, but it is generally compatible will any SQL database and is a complete disclosure of our the schema. There are four tables: Node, Edge, Node Property, and Edge Property. The fields in each table have been described above.

The in-memory data structure is similar in concept though implemented different for performance and efficiency reasons.

Because both model procedures and biological systems are represented in the same data-model (in the database) or data structure (in memory), property value references can be used to compute parameters in one model from parameters in another as demonstrated above.

Keywords in Math Expressions

A defined a set of context based mathematical keywords is provided to simplify the process of embedding mathematical expressions into a graph structure. A pre-processor converts these keywords into hierarchical name references prior to evaluation. Keyword replacement allows expressions to be written in terms of a node's context in the model instead of by using only absolute names. Some examples are:

Inputs.Value→evaluates to a comma separated list of hierarchical name references to the Value property for all nodes connected to this node. In this case it evaluates to “A.Value, B.Value”. Using keyword replacement, one can write sum(Inputs.Value) which will be property evaluated on any node in the graph based on local connectivity, for example, as illustrated in FIG. 10.

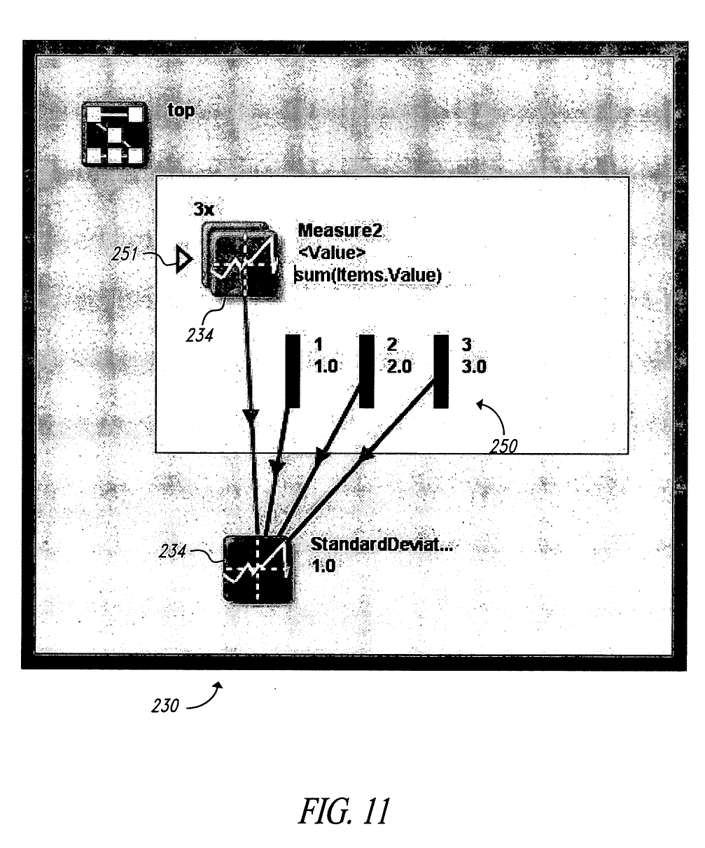

FIG. 10 also shows that the parameter or function “stdev(Inputs.Value)” is pre-processed to “stdev(Measure2.[1].Value, Measure2.[2].Value, Measure.[3].Value)”. And, it is re-evaluated any time that the graph structure changes. FIG. 11 shows that this expression correctly evaluates to 1. The goal is to simplify the entry and maintenance of such expressions.

Outputs.Value→evaluates to a comma separated list of hierarchical name references to Value properties for all nodes connected from this node.

Items.Value→evaluates to a comma separated list of hierarchical name references for all connections to the node, for example as shown in FIG. 11.

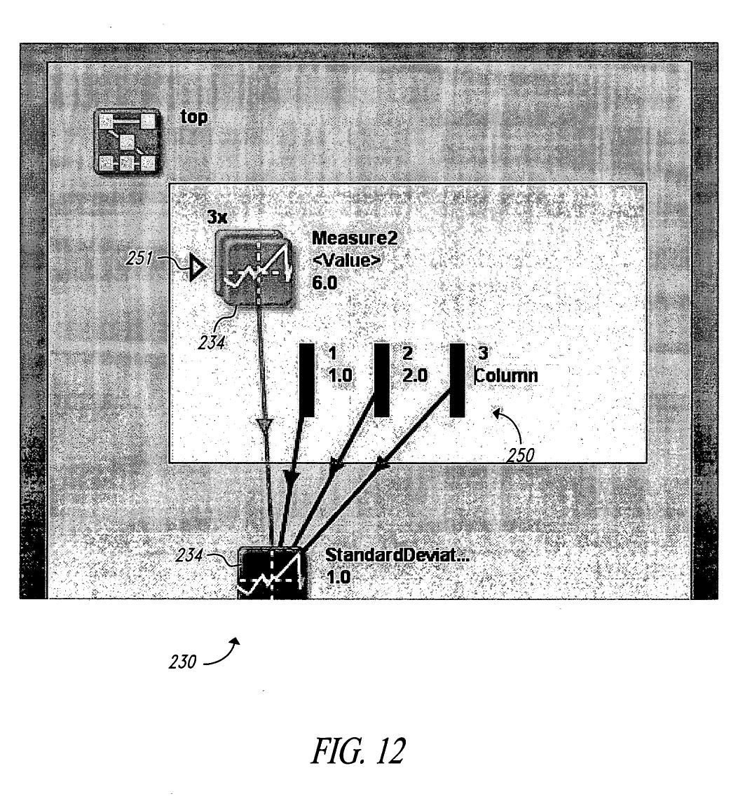

FIG. 12 shows that the parameter or function “Items.Value” is pre-processed to the same list as for previous example. Any time the contents of a hierarchical node are changed, this expression will be automatically re-evaluated.

Row, Column, or Plate→Evaluates to a node's position in a Batch (Refer to AutoFill provisional) along any dimension. For example, Row*Column evaluates to 15 if the node is in Row 3 and Column 5, for example in FIG. 12.

Thus, the value of each node in the batch is actually computed based on its position in the batch (e.g., which column).

Container.Value→evaluates to the hierarchical name reference for this nodes immediate container.

Though keyword replacement is not essential for Closed Loop modeling, it is very important from a usability standpoint. Keyword replacement can be extended to include any context based relationships in a graph model such as physical containment, logical containment, reachability, connectivity, hierarchy level, specific types of node or edges, etc.

Although specific embodiments of and examples for the apparatus and method of closed loop integration of in silico and physical modeling are described herein for illustrative purposes, various equivalent modifications can be made without departing from the spirit and scope of the invention, as will be recognized by those skilled in the relevant art. The teachings provided herein of the invention can be applied to other processor controlled systems, not necessarily the exemplary computing system generally described above. Likewise, the teachings provided herein of the invention can be applied to other workflow modeling tools, not necessarily the exemplary workflow modeling tool generally described above

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to commonly assigned U.S. provisional patent applications Ser. No. 60/454,756, filed Mar. 14, 2003, and entitled “METHOD, APPARATUS AND ARTICLE FOR GRAPHICAL MANIPULATION OF WORKFLOW USING EQUATIONS”; Ser. No. 60/493,749, filed Aug. 8, 2003, and entitled “BATCH-BASED METHOD AND TOOL FOR GRAPHICAL MANIPULATION OF WORKFLOWS”; Ser. No. 60/493,748, filed Aug. 8, 2003, and entitled “CLOSED LOOP INTEGRATION OF IN SILICO AND PHYSICAL MODELING”; Ser. No. 60/505,096, filed Sep. 22, 2003, and entitled “BATCH-BASED METHOD AND TOOL FOR GRAPHICAL MANIPULATION OF WORKFLOWS”; Ser. No. 60/508,109, filed Oct. 2, 2003, and entitled “CLOSED LOOP INTEGRATION OF IN SILICO AND PHYSICAL MODELING”; and Ser. No. 60/543,859, filed Feb. 11, 2004, and entitled “BATCH-BASED METHOD AND TOOL FOR GRAPHICAL MANIPULATION OF WORKFLOWS”; and U.S. patent application Ser. No. 10/799,451, filed Mar. 11, 2004, and entitled “BATCH-BASED METHOD AND TOOL FOR GRAPHICAL MANIPULATION OF WORKFLOWS,” are each incorporated herein by reference, in their entirety. Aspects of the invention can be modified, if necessary, to employ systems, circuits and concepts of the various patents, applications and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include integrated in silico and physical modeling methods, apparatus and articles that operate in accordance with the claims. Accordingly, the invention is not limited by the disclosure, but instead its scope is to be determined entirely by the following claims.

1. A system to interrelate digital models of physical systems and digital models experimental procedures, the system comprising:
means for forming a digital model of a physical system, the digital model of the physical system comprising a plurality of hierarchical node objects and a plurality of hierarchical edge objects, at least some of the hierarchical node objects representing a respective element of the physical system and each of the hierarchical edge objects defining a relationship between at least a respective pair of the hierarchical node objects;
means for forming a digital model of an experimental procedure, the digital model of the experimental procedure comprising a plurality of hierarchical node objects and a plurality of hierarchical edge objects, at least some of the hierarchical node objects representing a respective operation of the experimental procedure and each of the hierarchical edge objects defining a relationship between at least a pair of the hierarchical node objects; and
means for updating at least one parameter in a first one of the digital models based on at least one outcome of a second one of the digital models.

2. The system of claim 1 wherein the means for updating at least one parameter in a first one of the digital models based on at least one outcome of a second one of the digital models comprises means for updating at least one parameter in the digital model of the physical system based on at least one outcome of the digital model of the experimental procedure.

3. The system of claim 1 wherein the means for updating at least one parameter in a first one of the digital models based on at least one outcome of a second one of the digital models comprises means for updating at least one parameter in the digital model of the experimental procedure based on at least one outcome of the digital model of the physical system.

4. The system of claim 1 wherein the means for forming a digital model of a physical system comprises a set of user selectable icons, at least some of the user selectable icons associated with respective ones of a number of object types, the object types representative of respective ones of a number of experimental procedure operations, the object type having a number of properties associated therewith.

5. The system of claim 1 wherein the means for forming a digital model of an experimental procedure comprises a set of user selectable icons, at least some of the user selectable icons associated with respective ones of a number of object types, the object types representative of respective one of a number of physical system elements, the object type having a number of properties associated therewith.

6. The system of claim 1 wherein the means for forming a digital model of a physical system comprises a set of user selectable icons, at least some of the user selectable icons associated with respective ones of a number of object types, the object types representative of respective ones of a number of experimental procedure operations, the object type having a number of properties associated therewith, and wherein the means for forming a digital model of an experimental procedure comprises a set of user selectable icons, at least some of the user selectable icons associated with respective ones of a number of object types, the object types representative of respective one of a number of physical system elements, the object type having a number of properties associated therewith, where a parameter space of the object types associated with the first set of user selectable icons is related mathematically to a parameter space of the object types of the second set of user selectable icons in a single computing environment.

7. The system of claim 1, further comprising:
determining at least one value of at least one parameter of the second one of the digital models of the physical system and the experimental procedure; and
updating at least one value for at least one parameter of the first one of the digital models based on the determined at least one value of the at least one parameter of the second one of the digital models.

8. The system of claim 1 wherein each of the hierarchical nodes objects has associated therewith a respective dimensionality defining a number of dimensions of the respective hierarchical node object, the respective dimensions of each of the hierarchical node objects having a defined order with respect to one another, each dimension having an associated size defining a number of members of the respective dimension, and for each of a number of pairs of hierarchical node objects connected by a respective shared one of the hierarchical edge objects, associating at least one of a number of match rules with the pair of hierarchical node objects, each of the match rules defining at least one matrix transformation between the hierarchical node objects of the respective pair, application of the matrix transformation to the members of the hierarchical node objects of the respective pair defining a resulting set of primitive nodes and primitive edges, where a first one of the number of match rules defines a first matrix transformation between the first and the second hierarchical node objects.

9. The system of claim 1 wherein the digital model of the physical system comprises at least one group of parameter values that are associable with a number of points in a coordinate space defined by a dimensionality of the digital model of the experimental procedure, either directly or through one or more mathematical transformations.

10. A computer-readable media containing a data structure to interrelate digital models of physical systems and digital models of experimental procedures, the data structure comprising:
a first set of hierarchical node objects, each of the hierarchical node objects having associated therewith a respective dimensionality defining a number of dimensions of a respective hierarchical node, the respective dimensions of each of the hierarchical node objects having a defined order with respect to one another, each dimension having an associated size defining a number of members of the respective dimension, at least some of the hierarchical node objects of the first set of hierarchical node objects representing respective ones of a set of elements of physical system, wherein at least a portion of a parameter space of the first set of hierarchical node objects is related to at least a portion of a parameter space of a second set of hierarchical node objects at least some of which represent a set of operations of an experimental procedure in a same computing environment as the hierarchical node objects of the first set of hierarchical node objects.

11. The data structure of claim 10 wherein the at least a portion of the parameter spaces of the first and the second sets of hierarchical node objects are related mathematically by way of at least one matrix transformation.

12. The data structure of claim 10 wherein the at least a portion of the parameter spaces of the first and the second sets of hierarchical node objects are related directly to one another.

13. The data structure of claim 10, further comprising:
a first set of hierarchical edge objects, at least some of the hierarchical edge objects forming hierarchical relationships between respective pairs of the hierarchical node objects.

14. A method of interrelating a digital model of a physical system and a digital model of an experimental procedure, the method comprising:
determining at least one value of at least one parameter of a first one of a digital model of a physical system or a digital model of an experimental procedure; and
updating at least one value for at least one parameter of a second one of the digital models based on the determined at least one value of the at least one parameter of the first one of the digital models.

15. The method of claim 14, further comprising:
graphically presenting a plurality of hierarchical node icons and hierarchical edge icons in a first display environment, at least some of the hierarchical node icons representing respective instances of elements of the digital model of the physical system, and the hierarchical edge icons extending between respective pairs of the hierarchical node icons and representing hierarchical relationships between the respective elements of the digital model of the physical system; and
graphically presenting a plurality of hierarchical node icons and hierarchical edge icons in the first display environment, at least some of the hierarchical node icons representing respective operations of a digitally modeled experimental procedure, and the hierarchical edge icons extending between respective sets of the hierarchical node icons and representing hierarchical relationships between the respective operations of the digitally modeled experimental procedure.

16. The method of claim 14 wherein determining at least one value of at least one parameter of a first one of a digital model of a physical system or a digital model of an experimental procedure comprises:
executing the experimental procedure that is digitally modeled;
collecting data from the execution of the experimental procedure; and
evaluating the collected data from the execution of the experimental procedure.

17. The method of claim 14 wherein determining at least one value of at least one parameter of a first one of a digital model of a physical system or a digital model of an experimental procedure comprises:
executing the physical model in silico;
collecting data from the execution of the physical model; and
evaluating the collected data from the execution of the physical model.

18. The method of claim 14 wherein the updating at least one value for at least one parameter of a second one of the digital models occurs in a same computing environment as the determining at least one value of at least one parameter of a first one of a digital model of a physical system or a digital model of an experimental procedure.

19. The method of claim 14, further comprising:
determining at least one value of at least one parameter of the second one of the digital models of the physical system and the experimental procedure; and
updating at least one value for at least one parameter of the first one of the digital models based on the determined at least one value of the at least one parameter of the second one of the digital models.

20. A method of interrelating digital models of physical systems and experimental procedures, the method comprising:
digitally modeling a physical system with a plurality of hierarchical node objects and a plurality of hierarchical edge objects, at least some of the hierarchical node objects representing an element of the physical system and each of the hierarchical edge objects defining a relationship between a respective one of a number of pairs of the node objects;
digitally modeling an experimental procedure with a plurality of hierarchical node objects and a plurality of hierarchical edge objects, at least some of the hierarchical node objects representing an operation of the experimental procedure and each of the hierarchical edge objects defining a relationship between a respective one of a number of pairs of the hierarchical node objects;
determining at least one outcome of one of the digital models; and
updating a value of at least one parameter in the other one of the digital models based on the determined at least one outcome.

21. The method of claim 20 wherein determining at least one outcome of one of the digital models comprises:
collecting data from an execution of the experimental procedure; and
evaluating the collected data from the execution of the experimental procedure.

22. The method of claim 20 wherein determining at least one outcome of one of the digital models comprises:
automatically executing the experimental procedure that is digitally modeled;
collecting data from the execution of the experimental procedure; and
evaluating the collected data from the execution of the experimental procedure.

23. The method of claim 22, further comprising:
determining at least one outcome of the digital model of the physical system; and
updating a value of at least one parameter in the digital model of the experimental procedure based on the determined at least one outcome of the digital model of the physical system to form a closed loop feedback system in a single computing environment.

24. The method of claim 20 wherein determining at least one outcome of one of the digital models comprises:
collecting data from an in silico execution of the physical model; and
evaluating the collected data from the execution of the physical model.

25. A computer-readable media to cause a computer to interrelate digital models of physical systems and experimental procedures, by:
digitally modeling a physical system with a plurality of hierarchical node objects and a plurality of hierarchical edge objects, at least some of the hierarchical node objects representing an element of the physical system and at least some of the hierarchical edge objects defining a relationship between a respective one of a number of pairs of the node objects;
digitally modeling an experimental procedure with a plurality of hierarchical node objects and a plurality of hierarchical edge objects, at least some of the hierarchical node objects representing an operation of the experimental procedure and at least some of the hierarchical edge objects defining a relationship between a respective one of a number of pairs of the hierarchical node objects;
determining at least one outcome of one of the digital models; and
updating a value of at least one parameter in the other one of the digital models based on the determined at least one outcome.

26. The computer-readable media of claim 25 wherein determining at least one outcome of one of the digital models comprises:
executing the experimental procedure that is digitally modeled;
collecting data from the execution of the experimental procedure; and
evaluating the collected data from the execution of the experimental procedure.

27. The computer-readable media of claim 25 wherein determining at least one outcome of one of the digital models comprises:
automatically executing the experimental procedure that is digitally modeled;
collecting data from the execution of the experimental procedure; and
evaluating the collected data from the execution of the experimental procedure.

28. The computer-readable media of claim 27, further comprising:
determining at least one outcome of the digital model of the physical system; and
updating a value of at least one parameter in the digital model of the experimental procedure based on the determined at least one outcome of the digital model of the physical system to form a closed loop feedback system in a single computing environment.

29. The computer-readable media of claim 25 wherein determining at least one outcome of one of the digital models comprises:
executing the physical model in silico;
collecting data from the execution of the physical model; and
evaluating the collected data from the execution of the physical model.
